(19) United States
(12) Patent Application Publication
(10) Pub. No.: US 2014/0345811 A1
(43) Pub. Date: Nov. 27, 2014

(54) GARAGE DOOR OPENING COVERING

(71) Applicant: Gary McDaniel, Peoria, AZ (US)

(72) Inventor: Gary McDaniel, Peoria, AZ (US)

(21) Appl. No.: 14/284,158

(22) Filed: May 21, 2014

Related U.S. Application Data
(60) Provisional application No. 61/825,815, filed on May 21, 2013.

(51) Int. Cl. E06B 9/24; E06B 9/56

(52) U.S. Cl. CPC E06B 9/24; E06B 9/56
USPC 160/188

(57) ABSTRACT

A garage door opening covering is provided. The covering includes a plurality of panels coupled to a support member that is coupled to the interior surfaces of a garage door. The panels are configured to deploy into the garage door opening as the garage door is opened. Likewise the panels are configured to retract out of the garage door opening as the garage door is closed. The panels are configured to wrap around, or unwind from, the support member as the support member is rotated in respective first and second directions. The panels can include weighted members on suspended ends of the panels to position and orient the panels. The weighted members can include magnetized portions that couple neighboring panels to one another at the ends. A positioning member can position the suspended and deployed panels at or near the edge of the garage door that contacts the ground surface.

### CROSS REFERENCE TO RELATED APPLICATION

This application claims priority to U.S. Provisional Patent Application to McDaniel entitled “GARAGE DOOR OPENING COVERING,” Ser. No. 61/825,815, filed May 21, 2013, the disclosure of which is hereby incorporated entirely herein by reference.

### BACKGROUND

1. Technical Field

The following relates generally to a covering for a garage door opening, and in particular a covering configured in the open space vacated by an open garage door.

2. State of the Art

A residential garage is a space designed and/or used for storing the property of the residential owner. In most cases, the garage is enclosed and is used to store and protect the owner's vehicle(s) and/or recreational vehicle(s). A garage may be attached to the residence, but may also be detached therefrom. In either case, the garage functions as additional space that may be utilized by the owner of the garage. In addition to vehicles, an owner may choose to store other property within the garage, including tools, bicycles, lawn mowers and other such items.

As depicted in FIG. 1, an enclosed garage 2 generally has a garage door 4 that opens upward using a drive mechanism. The drive mechanism may be electrically powered and can often be remotely controlled from the residence or from the owner's vehicle with a transmitter. The door 4 may be opened to expose a garage opening 6, as depicted in FIG. 2, the garage opening 6 permitting the vehicle(s) and/or the residents to enter or exit the garage, as desired.

Garages may also be used for other purposes in addition to storage. It may be used as a work space for home improvement projects. In fact, some home owners choose to acquire an array of power tools that they place in the garage and thus prefer to spend large amounts of time in the garage working on project after project. Such work can be therapeutic and rewarding. Other homeowners choose to utilize the space of the garage as an entertainment and recreation room, wherein couches, TV's, wet bars, pool tables, and the like are kept for the enjoyment of the homeowner and guests.

Garages, whether attached or detached, are often not climate controlled by central air. Most of the time, the interior garage space is cooled or heated by opening the garage door to permit ambient air to enter within the interior garage space. In these circumstances, with the garage door wide open, it is difficult for the home owner to maintain any semblance of privacy. This problem is exaggerated at night, when the light from within the open garage attracts the gaze of every passerby. Thus, the homeowner is left with the decision to open the garage to the ambient air or to keep the garage closed to maintain privacy within the garage. In addition, at times the homeowner wishes to have ambient air flow into the garage space, but at the same time wishes to avoid direct sunlight into the garage space.

There is thus a need in the industry for a garage door covering that permits the homeowner to easily open the garage door to the ambient air while not only maintaining privacy within the garage but also preventing direct sunlight from entering the garage space.

### SUMMARY

The following relates to a covering for a garage door opening, and in particular a covering configured in the open space vacated by an open garage door.

A first general aspect of the disclosure relates to a covering for a garage door opening, the covering comprising a plurality of panels configured to transition between a refracted position and a deployed position, a support member coupled to a garage door, the support member configured to support the plurality of panels thereby, the support member configured to functionally engage the plurality of panels, a deployment mechanism functionally coupled to the support member and configured to operate to transition the plurality of panels between the retracted position and the deployed position, and a weighted member coupled to a distal end of each of the plurality of panels.

Another general aspect of the disclosure relates to wherein under a condition the garage door is in a closed position the plurality of panels are in the retracted position, and wherein under a condition the garage door is in an open position the plurality of panels are in the deployed position to cover at least a portion of the garage door opening.

Another general aspect of the disclosure relates to a positioning member functionally coupled proximate a distal end of the garage door, wherein the positioning member is configured to functionally engage the plurality of panels to place a portion of each panel proximate the distal end of the garage door under a condition the garage door is open and the plurality of panels are in the deployed position.

Another general aspect of the disclosure relates to wherein each of the weighted members further comprises coupling members, the coupling members being configured to functionally engage one another to releasably couple adjacent panels of the plurality of panels to one another.

Another general aspect of the disclosure relates to wherein at least one panel of the plurality of panels exhibits diaphanous properties.

Another general aspect of the disclosure relates to wherein the plurality of panels substantially covers the garage opening without contacting a ground surface.

Another general aspect of the disclosure relates to wherein at least one panel of the plurality of panels deploys and retracts to the degree the garage door opens and closes, respectively.

Another general aspect of the disclosure relates to wherein the positioning member is positioned closer to the distal end of the garage door than is the support member.

Another general aspect of the disclosure relates to wherein the each panel is configured to drape over the positioning member.

Another general aspect of the disclosure relates to a system for covering for a garage door opening, the system comprising a plurality of panels configured to transition between a retracted position and a deployed position, wherein adjacent panels of the plurality of panels define therebetween an opening, at least one support member coupled to a garage door, the at least one support member configured to support a corresponding number of the plurality of panels thereby, the at least one support member configured to functionally engage the corresponding panels, a deployment mechanism functionally coupled to the at least one support member and configured to operate to transition the corresponding panels between the retracted position and the deployed position, a positioning member functionally coupled proximate a distal end of the garage door, wherein the positioning member is configured to functionally engage the plurality of panels, a coupling member configured between distal ends of adjacent panels, wherein under a condition the garage door is open and the plurality of panels are in the deployed position, the positioning member places a portion of each panel proximate the distal end of the garage door and the coupling member permits adjacent panels to disengage from one another under applied force and to operatively couple to one another in an absence of the applied force.

Another general aspect of the disclosure relates to wherein under a condition the garage door is in a closed position the plurality of panels are in the refracted position, and wherein under a condition the garage door is in an open position the plurality of panels are in the deployed position to cover at least a portion of the garage door opening.

Another general aspect of the disclosure relates to wherein the plurality of panels each exhibit diaphanous properties.

Another general aspect of the disclosure relates to wherein the plurality of panels substantially covers the garage opening from a distal end of the garage door to a ground surface without contacting the ground surface.

Another general aspect of the disclosure relates to wherein at least one panel of the plurality of panels deploys and retracts to the degree the garage door opens and closes, respectively.

Another general aspect of the disclosure relates to wherein the positioning member is positioned closer to the distal end of the garage door than is the support member.

Another general aspect of the disclosure relates to wherein the each panel is configured to drape over the positioning member.

Another general aspect of the disclosure relates to a system for covering for a garage door opening, the system comprising a plurality of panels exhibiting diaphanous properties configured to transition between a retracted position and a deployed position, wherein adjacent panels of the plurality of panels define therebetween an opening, a plurality of support members coupled to a garage door, each of the plurality support members being configured to support a corresponding number of the plurality of panels thereby, each of the support members being configured to functionally engage the corresponding panels, a deployment mechanism functionally coupled to a corresponding support member of the plurality of support members and configured to operate the support member to transition the corresponding panels between the retracted position and the deployed position, a positioning member functionally coupled proximate a distal end of the garage door, wherein the positioning member is configured to functionally engage the plurality of panels such that the positioning member has draped thereover the plurality of panels and places a portion of the panel proximate the distal end of the garage door, and a coupling member configured between distal ends of adjacent panels, wherein under a condition the garage door is open and the plurality of panels are in the deployed position the coupling member permits adjacent panels to disengage from one another under applied force and to operatively couple to one another in an absence of the applied force.

Another general aspect of the disclosure relates to wherein each support member of the plurality of support members is configured to operate independently of other support members to transition the corresponding plurality of panels between the refracted position and the deployed position.

Another general aspect of the disclosure relates to wherein each support member of the plurality of support members is configured to operate independently of other support members to transition the corresponding plurality of panels to cover at least a portion of the garage door opening.

Another general aspect of the disclosure relates to a coupler positioned proximate the distal end of each panel of the plurality of panels and a securing strap, wherein the securing strap is configured to operatively engage each coupler to retain the panels in position with respect to one another.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members.

FIG. 1 is a perspective view of an exemplary garage, wherein the garage is configured to have a conventional garage door that is configured to open to expose the interior of the garage space and to close to seal off the garage space.

FIG. 2 is a perspective view of the interior of an exemplary conventional garage space viewed through an opening in the garage, the opening being exposed when an exemplary conventional garage door is removed from the opening, typically by raising the garage door into the upper regions of the garage space.

FIG. 3 is a front view of an embodiment of a covering of a garage door opening taken from the outside of the garage space looking into the garage space, in accordance with the present disclosure.

FIG. 4 is a rear view of an embodiment of a covering of a garage door opening taken from the inside of the garage space looking out from the garage space, in accordance with the present disclosure.

FIG. 5 is a side perspective view of an embodiment of a covering of a garage door opening taken from the inside of the garage space looking out from the garage space, in accordance with the present disclosure.

FIG. 6 is a close-up rear view of a component of an embodiment of a covering of a garage door opening taken from the inside of the garage space looking out from the garage space, in accordance with the present disclosure.

FIG. 7 is a close-up rear view of a component of an embodiment of a covering of a garage door opening taken from the inside of the garage space looking out from the garage space, in accordance with the present disclosure.

FIG. 8 is a close-up side perspective view of an embodiment of a covering of a garage door opening looking down the width of the covering, in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

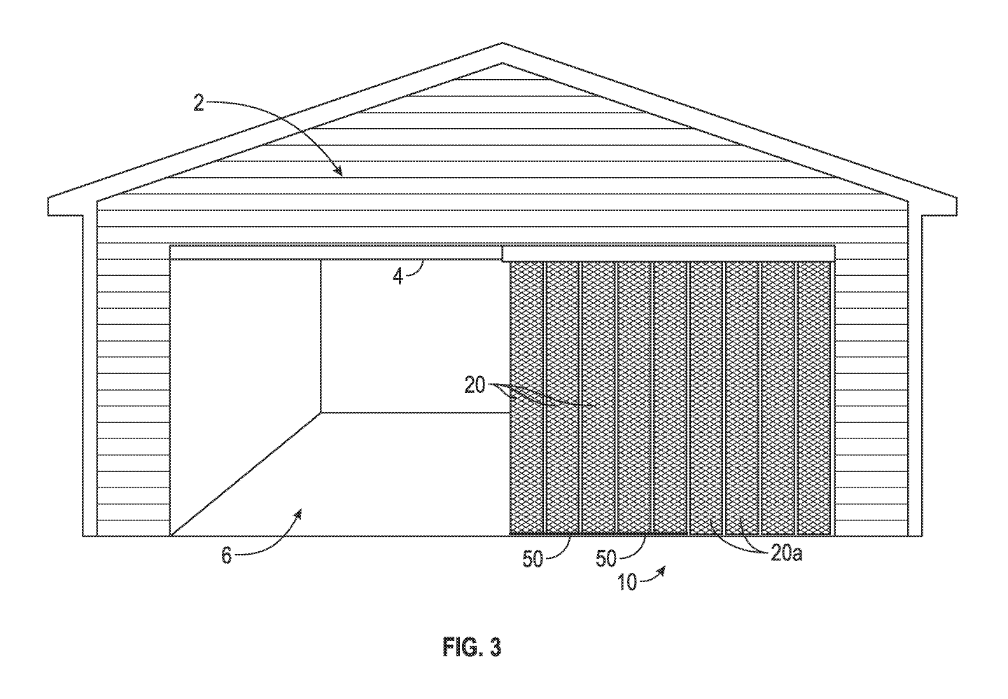

Referring to the drawings, FIGS. 3-5 depict an exemplary embodiment of a covering 10 of a garage door opening 6. Embodiments of the covering 10 may comprise, among other components described herein, a plurality of panels 20, a support member 30, a deployment mechanism 40, weighted members 50, and a positioning member 60.

Embodiments of the covering 10 may comprise a plurality of panels 20. Embodiments of the panels 20 may further comprise each of the panels 20 having a predetermined length. Each of the panels 20 may be configured to be a length that approximates a distance D that may be measured from a lower end of the garage door 4 when the garage door is in the open position to a ground surface with which the garage door 4 is configured to make contact when the garage door 4 is closed. A first end 22 of each panel 20 may be functionally coupled to the garage door 4 or to a support member 30 that is functionally coupled to the garage door 4. A second end 24 of each panel 20 may be configured to oppose the first end 22, to allow the panel 20 to remain suspended in the garage door opening 6 under the condition the garage door 4 is open. In this way, under the condition the garage door 4 is in the open position and the garage door opening 6 is exposed, the length of the panels 20 may be configured to cover a majority, or all, of the opening 6. In other words, the panels 20 may be configured to have a requisite length to cover, or otherwise block visual access to, the garage interior through the garage opening 6 when the garage door 4 is open. Embodiments of the covering 10 may further comprise each of the panels 20 having the same length. Embodiments of the covering 10 may further comprise each of the panels 20 having a varying length, depending on the requirements of the particular garage door opening 6. Further, embodiments of the covering 10 may further comprise each of the panels 20 having a uniform custom length, depending on the requirements of the particular garage door opening 6.

Embodiments of the covering 10 may further comprise each of the panels 20 being configured to have a width that is less than a width of the garage door opening 6, and in particular each of the panels 20 may be configured to have a width that is substantially less than the width of the garage door opening 6. Embodiments of the covering 10 may further comprise each of the panels 20 having a varying width, from panel 20 to panel 20 or within each panel 20, depending on the requirements of the particular garage door opening 6. As a non-limiting example, the covering 10 may be comprised of a plurality of panels 20 each having a width of about 2 feet, such that four panels 20 may cover a width of about 8 feet and eight panels may cover a width of about 16 feet (or the standard width of a two-car garage).

Embodiments of the covering 10 may further comprise neighboring panels defining therebetween a space 26 that may be configured to separate each panel 20 from neighboring/adjacent panels 20 in the covering 10. The space 26 may be configured to have a width that is as small as possible and yet adequate enough to separate each panel 20 from one another without neighboring panels 20 conflicting with one another in their respective movements. However, there is a limit to the width of the space 26, because the wider the space 26, the less concealing the covering 10 becomes. Accordingly, it is better to configure the space 26 to be as small as reasonably feasible. Further, the space 26 may allow fluidic communication between the interior and the exterior of the garage space. In other words, the spaces 26 may provide adequate openings through which air may pass to vent the interior garage space. In this way, not only can the garage space fluidicly communicate with the ambient air, but the force of the wind may be diffused against the collective covering 10 embodied by the individual panels 20. For example, the force of the wind may pass through the spaces 26 to diffuse the impact against the panels 20, which permits the collective covering 10 to remain in place in the garage opening to provide its concealing function.

In accordance with the above, embodiments of the covering 10 may further comprise a plurality of panels 20 being configured to be placed side-by-side within the garage door opening 6 to provide coverage over the opening 6. By placing a plurality of panels 20 within the opening 6 with a space 26 therebetween, each of the panels 20 may be configured to move independently from either neighboring panels 20 or any other panel 20 that comprises the covering 10. Thus, as external forces, such as wind, heat flow, air drafts, other air movement, chemical fumes, or even human interaction act on the panels 20, each of the panels 20 may bend, flex, displace, or otherwise move with respect to other panels 20 without forcing or causing other panels 20 to likewise move or without forcing or causing the entire covering 10 to displace out of its preferred position. Specifically, by configuring the covering 10 to include more than one panel 20, each panel 20 may be configured to move independently from other panels 20, but yet each panel 20 may nevertheless be considered to form part of the bigger whole—the covering 10. The space 26 between neighboring panels 20 may be configured to allow one panel 20 to move while a neighboring panel 20 remains in position without moving. As a general note, wide panels, or a covering that is comprised of one large panel (i.e., one large covering) may be more prone to resist movement from external forces due to weight considerations, while narrow, individual panels may be more susceptible to movement caused by external forces, due their small relative weight.

Embodiments of the covering 10 may include panels 20 having varying widths depending on the need of the particular garage opening 6. For example, and not by way of limitation, embodiments of the covering 10 may further comprise each of the panels 20 having a width of about 4-28 inches to achieve the results described above. Additional embodiments of the covering 10 may further comprise each of the panels 20 having a width of about 8-24 inches to achieve favorable results according to the discussion above. Additional embodiments of the covering 10 may further comprise each of the panels 20 having a width of about 12-20 inches to achieve favorable results according to the discussion above. Additional embodiments of the covering 10 may further comprise each of the panels 20 having a width of about 16 inches to achieve favorable results according to the discussion above. Additional embodiments of the covering 10 may further comprise each of the panels 20 having a width of about 24 inches to achieve favorable results according to the discussion above.

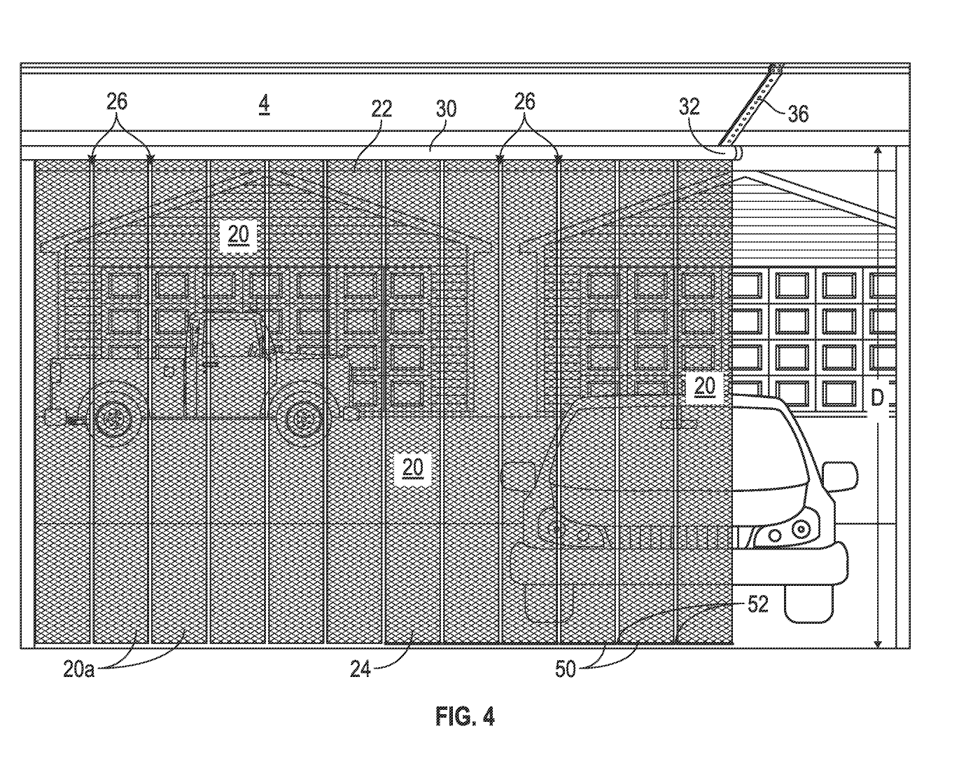

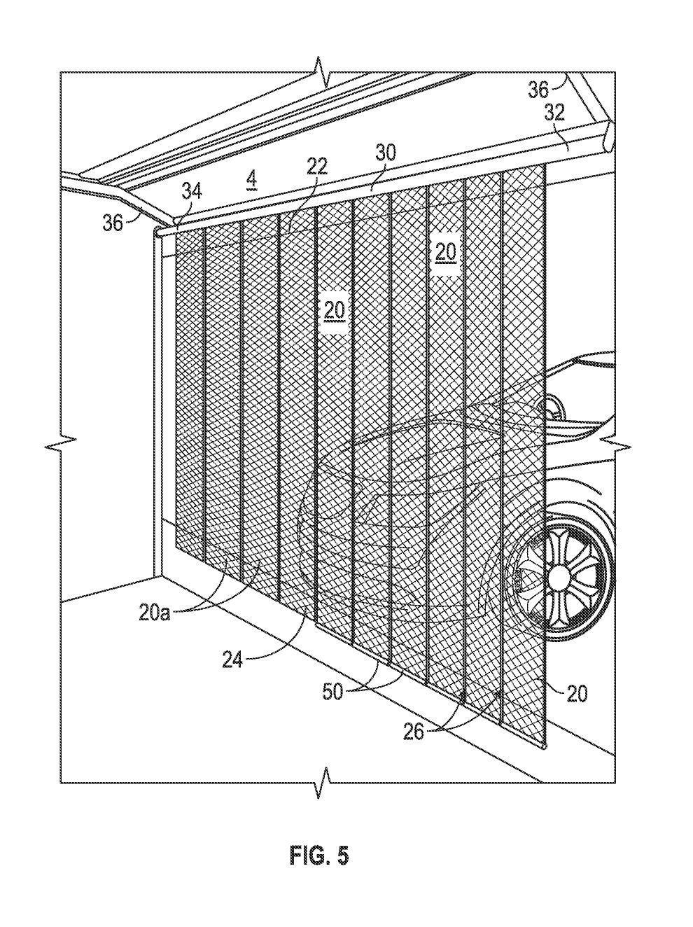

Embodiments of the covering 10 may further comprise one or more of the panels 20 consisting of one or more materials that may be flexible and/or non-rigid, such as a textile or other cloth material. Moreover, the materials comprising one or more of the panels 20 may be substantially translucent, transparent, or otherwise diaphanous, to allow light to pass there through. In addition to the above, one or more of the panels 20 may be comprised of materials that exhibit the property of preventing visibility there through when direct light is incident on the material, as depicted in FIG. 3 (visibility into the garage space is restricted by the panels 20), but yet exhibits translucent, transparent, or diaphanous properties when indirect light or an absence of light is incident on the material, as depicted in FIGS. 4 and 5 (visibility out of the garage space is permissible through the panels 20). The weight of the fibers, the linear mass density of the fibers, and/or the weave pattern of the panels 20 may be consistent with the function and structure described herein. Embodiments of the covering 10 may comprise the panels 20 having a small linear mass density and a loose weave pattern, to permit light to pass there through. Embodiments of the covering 10 may comprise the panels 20 having a large linear mass density and a tight weave pattern, to limit the amount of light that may pass there through. Embodiments of the covering 10 may comprise the panels 20 having an average linear mass density and a regular weave pattern, to permit average amounts of light to pass there through.

Embodiments of the covering 10 may further comprise one or more of the panels 20 consisting of a backing material (not depicted) that may be releasably or fixedly coupled to the interior side of the individual panel 20 to create a thicker density of the panel 20. In this way, having a thicker density, reduces the amount of light that may pass through the panel 20 with the backing thereon. This may be beneficial during nighttime operation of the covering 10, wherein without ambient light incident on the covering 10, the artificial garage light may cause persons outside the garage space to be able to see inside the garage space. However, with the backing attached, the artificial light from within the garage space may be prevented from escaping through the panel 20, which might otherwise permit persons to view inside the garage space through the panel 20. The backing may be a material that is sewn to the panel 20 or may be a material that is glued to the panel 20. The backing may also be a material that is independently coupled to the support member 30 and supported thereby. Thus, as the support member 30 rotates, the backing material may roll up thereon, as discussed herein with regard to the panels 20.

With reference to FIGS. 4 and 5, embodiments of the covering 10 may further comprise a support member 30. The support member 30 may comprise a beam-like member, such as but not limited to a rod, pole, bar, shaft, tube, pipe, or other similar member. The support member 30 may have a first end 32 and a second end 34, the second end 34 opposing the first end 32. The support member 30 may be configured of rigid materials, such as metals, plastics, composites, or other like materials that are capable of supporting weight thereon. Embodiments of the covering 10 may further comprise the support member 30 being configured to be coupled directly to the garage door 4. The support member 30 may be coupled to the garage door 4 at first and second ends 32 and 34.

Embodiments of the covering 10 may further comprise the support member 30 being configured to be formed integrally with the garage door 4, such that the covering is an integral portion of the garage door 4. As such, the covering 10 may be manufactured directly into the garage door 4.

Embodiments of the covering 10 may further comprise the support member 30 being configured to be functionally coupled the garage door 4 via braces 36. The braces 36 may be coupled to existing structure of the garage door 4, such that the braces 36 may be coupled to garage doors 4 already in place on existing garages. The braces 36 may be configured to be coupled to the interior surfaces of the garage door 4. The braces 36 may be configured to support the weight of the support member 30 on the garage door 4 once the support member 30 is functionally coupled to the braces 36. The support member 30 may be coupled to the braces 36 at first and second ends 32 and 34. In other words, a brace 36 may functionally couple the first end 32 to the garage door 4, while another brace 36 may functionally couple the second end 34 to the garage door 4.

Embodiments of the covering 10 may further comprise the support member 30 being functionally coupled to the garage door 4 at lower regions of the garage door 4, such that the support member 30 may be positioned at or near the opening 6 of the garage 2 under a condition the garage door 4 is open. Moreover, by being coupled to the garage door 4, the support member 30 may be configured to move with the garage door 4 as the garage door 4 moves.

Embodiments of the covering 10 may further comprise the support member 30 being configured to have a length substantially similar to the width of the garage door 4, or, alternatively, the width of the garage opening 6. In other words, the support member 30 may be configured to have a length that spans the width of the garage door 4. Embodiments of the covering 10 may further comprise the support member 30 being configured to have a length less than the width of the garage door 4 or the garage door opening 6. As such, one or more support members 30 may be utilized to span the width of the garage door 4 or the garage door opening 6. Each of the plurality of support members 30 may be individually coupled to the garage door 4 or functionally coupled to the garage door 4 via the braces 36, as described above. In this way, each of the support members 30 that span the width of the garage door 4 may be operated independently from other support members 30 in the span. It follows therefore that the individual panels 20 coupled to each of the individual support members 30 may be operated independently of the other individual panels 20 coupled to another of the individual support members 30. As a non-limiting example, the covering 10 may comprise a plurality of support members 30, and in particular cases, the covering 10 may comprise two support members 30 positioned side-by-side, such that each of the support members 30 spans one-half of the garage opening 6. In this way, the covering 10 may be configured to have a left-side operation and a right-side operation, or a first half operation and a second half operation, in that each half of the covering 10 may operate independently of the other half. This provides the advantage that a vehicle may be backed out of or inserted through of one half of the garage door opening 6 while the other half of the same garage door opening 6 is covered by the covering 10, or vice versa. This further provides for partial coverage of the garage door opening, as desired by the user.

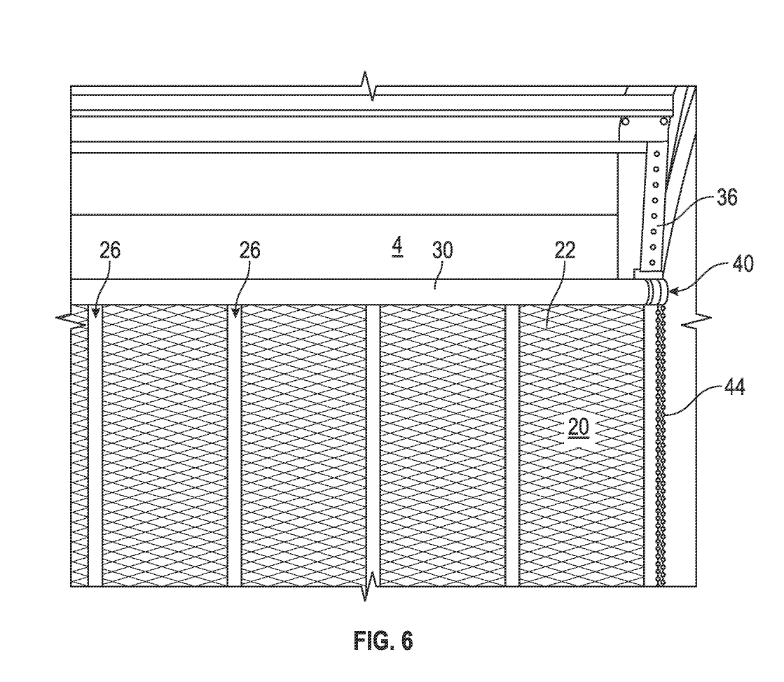

With reference to FIG. 6, embodiments of the covering 10 may further comprise a deployment mechanism 40 operating in cooperation with the support member 30. The deployment mechanism 40 may be configured to permit the support member 30 to exhibit rotary motion about its own axis, which is substantially parallel with the width of the garage door 4. The deployment mechanism 40 may be positioned between the support member 30 and the garage door 4/braces 36, such that the deployment mechanism 40 may allow the support member 30 to rotate, or otherwise spin, about its own axis. The deployment mechanism 40 may be a ball-bearing mechanism, a ball-and-joint mechanism, a geared mechanism, or other like mechanism that allows the support member 30 to couple thereto and yet rotate with respect thereto. In other words, while portions of the deployment mechanism 40 may remain fixedly coupled to the garage door 4 and/or braces 36, other portions of the deployment mechanism 40 may permit the support member 30 to rotate. Alternatively, the deployment mechanism 40 may be a drive mechanism that drives the rotation of the support member 30. In addition thereto, an operating device 44 may be coupled to the deployment mechanism 40 to activate the deployment mechanism 40. The operating device 44 may be a remote control or other electronic means that instructs operation of the deployment mechanism 40 to rotate or permit rotation of the support member 30. In addition thereto, the operating device 44 may be a cable or other manually-operated means that permits a user to control operation of the deployment mechanism 40. In other words, the deployment mechanism 40 may be configured to be activated and operated electronically (wireless or wired), manually, or both. As depicted, the user of the covering 10 may manually operate the operating device 44 (i.e., a cord) to cause the deployment mechanism 40 to rotate the support member 30 or to permit the support member 30 to rotate.

Rotation of the support member 30 may permit the panels 20 to transition between a retracted position and a deployed position. Embodiments of the covering 10 may further comprise the support member 30 being configured to have coupled thereto one or more of the panels 20, such that the support member 30 may support the panels 20 in position with respect to the garage door 4 and the garage opening 6. With the panel 20, or panels 20, coupled to the support member 30, the panel 20 may be wrapped around the support member 30 as the support member 30 rotates in a first direction. As the support member 30 rotates to wrap up the panel 20, the length of the panel 20 is reduced. The support member 30 may continue to rotate in the first direction to wrap the panel 20 there around until the second end 24 of the panel 20 is proximate the support member 30. With the second end 24 of the panel 20 near the support member 30, the panel 20 is thereby removed from the opening 6 of the garage 2. In this position, the panels 20 are in a retracted position. Conversely, the panels 20 may be transitioned from the retracted position to a deployed position, where, in the deployed position, the panels 20 are positioned within the opening 6 of the garage 2. To do so, the support member 30 may be rotated in a second direction opposite the first direction, such that the panels 20 will unwind from the support member 30. As the panels 20 unwind, the length of the panels 20 increases and extends into the opening 6 to cover the opening 6 thereby. The panels 20 may be configured to be repeatedly transitioned between the deployed position and the refracted position. The panels 20 may be configured to couple to the support member 30 between the first and second ends 32 and 34. The first end 22 of the panel 20 may be configured to couple to an exterior surface of the support member 30. As such, the panels 20 may wrap around an exterior of the support member 30. A covering (not depicted) may be placed over the wrapped panels 20 to conceal the panels 20 about the exterior of the support member 30. Alternatively, the first end 22 of the panel 20 may be configured to couple to an interior surface of the support member 30. As such, the panels 20 may wrap up within the interior of the support member 30 to be concealed from view.

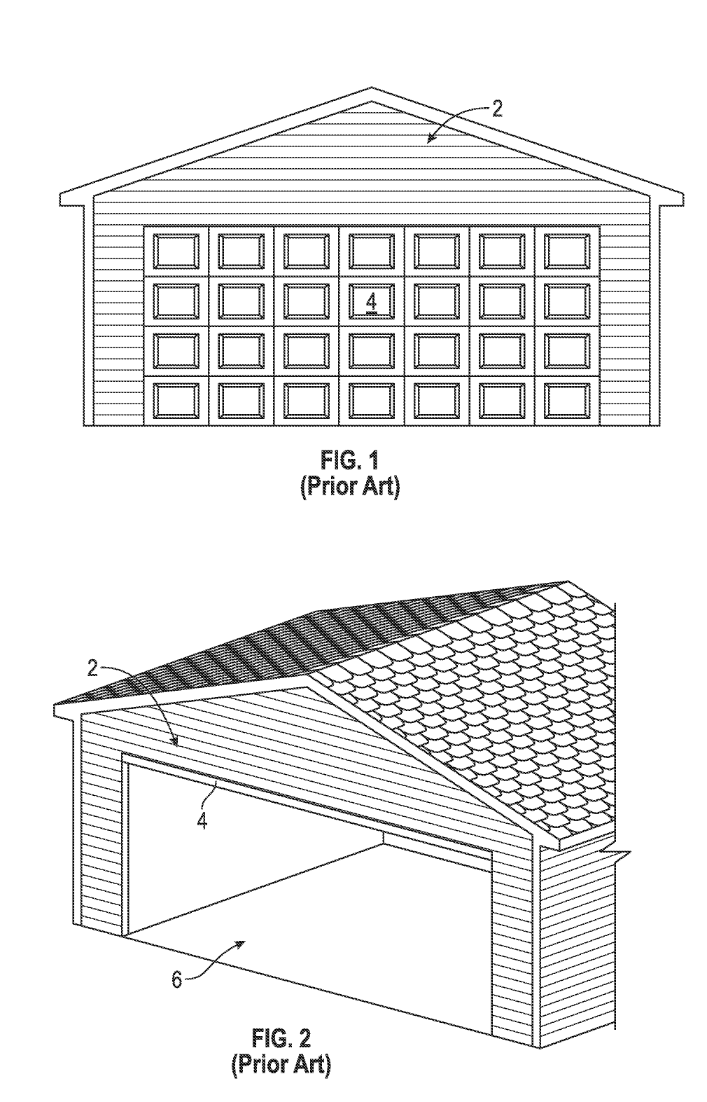

With reference again to FIGS. 1-3, embodiments of the covering 10 may further comprise a weighted member 50. The weighted member 50 may be coupled to the panel 20 at or near the second end 24. The weighted member 50 may be configured to provide sufficient mass to permit gravity to act on the weighted member 50 to pull taut the length of the panel 20. As depicted in FIGS. 1-3, the panels 20 that have the weighted member 50 positioned therein are held much more straight and taut versus those panels 20 that do not have the weighted member 50 positioned therein. For illustrative purposes, panels 20a in FIGS. 1-3 depict some of the panels 20 that do not have a weighted member 50 positioned therein. As such, these panels 20a are free to swing, twist, or otherwise move more freely than panels 20 that have the weighted members 50 therein. Indeed, with the weighted members 50 positioned in the second end 24, the first end 22 of the panels 20 may be suspended from the support member 30, and the weighted member 50 may act on the second end 24 to provide sufficient weight to pull down on the panel 20 to make the panel straight and appealing to the eye. Moreover, the weighted member 50 may act on the second end 24 to provide sufficient weight to prevent the panel 20 from moving to and fro with every force exerted on the panel 20, such as breeze and wind forces. In other words, the weighted member 50 may serve to add mass to the panel 20 to prevent the panel 20 from being easily displaced by external forces.

Embodiments of the covering 10 may comprise the weighted member 50 being further configured to have one or more coupling members 52 in distal regions of thereof. The distal regions of the weighted member 50 may be configured proximate the edge portions of the panel 20. The coupling members 52 may be configured in the distal regions of the weighted members 50 to allow neighboring weighted members 50 to couple to one another, or, in functional terms, to essentially allow the second ends 24 of neighboring panels 20 to couple to one another. As a non-limiting example, the coupling members 52 may be magnetized members or magnetized portions of the coupling members 52. Thus, the polarity of the magnetized portions functions to attract the respective second ends 24 of the panels 20 to one another. Of course, to do so, the magnetized portions would need to be reversed on neighboring weighted members 50 to achieve the desired magnetic attraction. The coupling members 52, once engaged, may be configured to prevent movement of neighboring panels 20 with respect to one another at their respective second ends 24. With the magnetized portions engaged with one another, air may yet pass through the spaces 26, but the panels 20 may be held more rigidly in place, such that the individual panels 20 function more like a single entity. The coupling members 52 may also serve to hold the panels 20 in a more uniform orientation. For example, and not in any way limiting, as a user desires to pass between neighboring panels 20 to enter or exit the garage space, the user may simply walk through any one of the spaces 26 to naturally disengage the coupling members 52 from one another due to the application of user-applied force (i.e., user-applied force may be considered an external force that is stronger than other external forces that wind or other air movements may exert on the covering 10, which would not normally operate to disengage the coupling members 52 from one another) to permit displacement of the panels 20 and allow the user to pass. Indeed, due to the weight and magnetized characteristics of the weighted portion 50 and the coupling members 52 thereon, the panels 20 may be configured to disengage and thereafter return to their normal straight orientation with respect to one another and thereby permit the coupling members 52 to couple to one another at the second ends 24, all without the user having to perform any manual operation, other than simply walking through the opening 26 to normally enter or exit the garage opening 6. Thus, such a configuration provides easy and convenient access to and from the garage opening 6 without the user having to manually reattach individual panels 20 to one another to complete the covering 10. Alternatively, the coupling members 52 may be coupled directly to the panels 20 without need of the weighted member 50. Alternatively, the coupling members 52 may be coupled at various points along the length of the individual panels 20 to permit neighboring panels 20 to couple to one another across the space 26.

Embodiments of the covering 10 may further comprise a coupler 58 thereon, such as for example, and not in any way limiting, a D-ring or other coupling hardware component that may receive and retain a securing strap 59. The coupler 58 may be included on the second ends 24 of each of the panels 20. Alternatively, the coupler 58 may be included on the weighted member 50 of each of the panels 20. The coupler 58 may be configured to receive and retain the securing strap 59 that may be threaded through the coupler 58 to functionally engage the coupler 58 to thereby functionally engage the associated panel 20. In operation, the securing strap 59 may be fed through two or more couplers 58 on respective panels 20 to physically and operatively couple the respective second ends 24 of the respective panels 20 to one another. In this way, the panels 20 may be prevented from disengaging from one another under strong application of external or applied force. In other words, under the condition the securing strap 59 is operatively coupled to the coupler 58 on each of the engaged panels 20, these engaged panels 20 may be prevented from disengaging from one another due to external forces acting thereon. A user may nevertheless pass through the opening 26 between neighboring panels 20, but the second ends 24 of the neighboring panels 20 would effectively remain in place with respect to one another due to the securing strap 59 engaging the respective coupler 58. The distal ends of the securing strap 59 may be configured to tie, bind, or otherwise secure to a coupler 58 on an end panel 20. Alternatively, the distal ends of the securing strap 59 may be configured to tie, bind, or otherwise secure to a portion of the garage door 4. Alternatively, the distal ends of the securing strap 59 may be configured to tie, bind, or otherwise secure to a portion of the ground surface or the garage interior. Embodiments of the coupler 58 and the securing strap 59 may comprise one securing strap 59 operatively coupling together the panels 20 that comprise one half of the garage door opening 6 and a second securing strap 59 operatively coupling together the panels 20 that comprise the other half of the garage door opening 6. Accordingly, the distal ends of the securing straps 59 that terminate at a midpoint of the garage door opening 6 may be tied off at a central region of the garage door 4 and may functionally couple to the garage door 4 itself, or, in the alternative, may be tied off to the coupler 58 on the panel 20 that terminates the use of the specific securing strap 59.

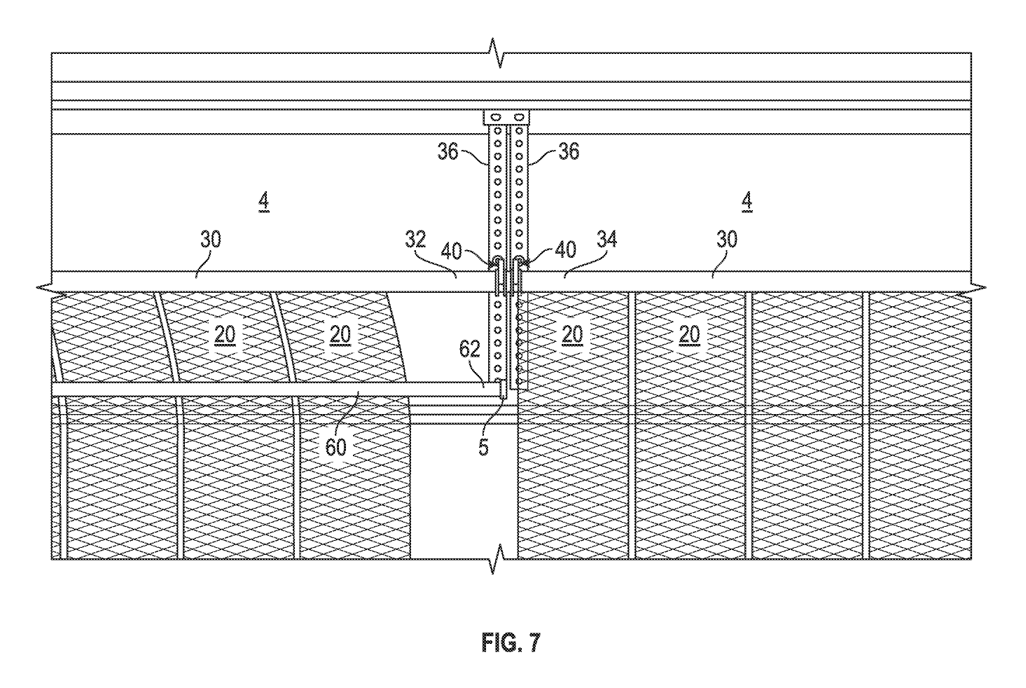

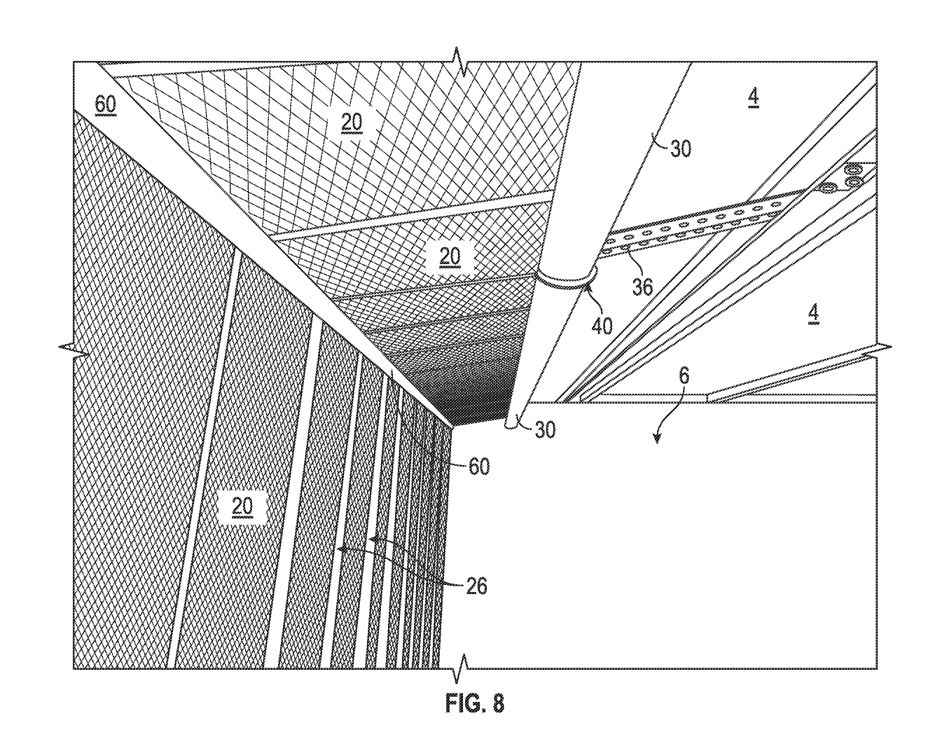

With reference now to FIGS. 7 and 8, embodiments of the covering 10 may further comprise a positioning member 60. The positioning member 60 may comprise a beam-like member, such as but not limited to a rod, pole, bar, shaft, tube, pipe, or other similar member. The positioning member 60 may have a first end 62 and a second end 64, the second end 64 opposing the first end 62. The positioning member 60 may be configured of rigid materials, such as metals, plastics, composites, or other like materials that are capable of supporting weight thereon. Embodiments of the covering 10 may further comprise the positioning member 60 being configured to be coupled directly to the garage door 4 at a location at or proximate a lower edge surface 5 of the garage door 4. The positioning member 60 may be coupled to the garage door 4 at first and second ends 62 and 64. Embodiments of the covering 10 may further comprise the positioning member 60 being configured to be formed integrally with the garage door 4. Embodiments of the covering 10 may further comprise the positioning member 60 being configured to be functionally coupled to the garage door 4 via braces 36. As mentioned above, the braces 36 may be coupled to existing structure of the garage door 4, such that the braces 36 may be coupled to garage doors 4 already in place on existing garages. The braces 36 may be configured to be coupled to the interior surfaces of the garage door 4. The braces 36 may be configured to support the weight of the positioning member 60 on the garage door 4 once the positioning member 60 is functionally coupled to the braces 36. The positioning member 60 may be coupled to the braces 36 at first and second ends 62 and 64. In other words, a brace 36 may functionally couple the first end 62 to the garage door 4, while another brace 36 may functionally couple the second end 64 to the garage door 4. The positioning member 60 may be functionally coupled to the garage door 4 at a position closer to the edge 5 of the garage door 4 than the support member 30. Moreover, by being coupled to the garage door 4, the positioning member 60 may be configured to move with the garage door 4 as the garage door 4 moves. Embodiments of the covering 10 may further comprise the positioning member 60 being configured to have a length substantially similar to the width of the garage door 4, or, alternatively, the width of the garage opening 6. In other words, the positioning member 60 may be configured to have a length that spans the width of the garage door 4. Embodiments of the covering 10 may further comprise the positioning member 60 being configured to have a length less than the width of the garage door 4 or the garage door opening 6. As such, one or more positioning members 60 may be utilized to span the width of the garage door 4 or the garage door opening 6. Each of the plurality of positioning members 60 may be individually coupled to the garage door 4 or functionally coupled to the garage door 4 via the braces 36, as described above. Embodiments of the covering 10 may further comprise the positioning member 60 being configured to have a length that is substantially equal to or corresponds to a length of a corresponding support member 30.

Embodiments of the covering 10 may further comprise one or more panels 20 being positioned over the positioning member 60 so as to be positioned between the interior surface of the garage door 4 and the positioning member 60. In this way, the positioning member 60 may hold or otherwise position the panel 20 at or near the edge 5 of the garage door 4. As depicted in FIG. 8, with the panels 20 positioned over the positioning member 60, the panels 20 are allowed to suspend from the positioning member 60 at or near the edge 5 of the garage door 4. This allows the support member 30 to be anchored to the interior of the garage door 4 at a position that will not interfere with the conventional sensors that sense whether there is an object in the path of a garage door 4 that is in the process of closing. If these sensors are tripped, then the garage door 4 will not close and, in fact, will automatically reopen as a safety feature. Thus, the support member 30 may be anchored to the garage door 4 up and away from these conventional sensors, yet the positioning member 60 may be utilized to avoid the conventional sensors and effectively position the panels 20 at or near the edge 5 of the open garage door 4. This serves to provide convenience to the relative placement of the support member 30 on the garage door 4 and to optimize the placement of the deployed and suspended panels 20 to maximize the interior of the garage space. By use of the positioning member 60, the panels 20 may drape over the positioning member 60 to better position the panels with respect to the garage door opening 6.

Embodiments of the covering 10 may further comprise sensors (not depicted) that are configured to operate in cooperation with the opening and closing of the garage door 4. Specifically, the sensors may be coupled to the deployment mechanisms 40 to instruct the deployment mechanisms 40 to rotate the support members 30 to deploy or retract the panels 20 in response to the position of the garage door 4. In other words, should the garage door 4 begin to open, the sensors may sense the movement of the garage door 4 (or the movement of the mechanical means by which the garage door 4 is moved) and instruct the deployment mechanism 40 to rotate the support member 30 to deploy the panels 20 into the exposed opening 6 to the degree the garage door 4 is opened, all the way up to the point that the garage door 4 is fully opened and the panels 20 are fully deployed. Likewise, should the garage door 4 begin to close, the sensors may sense the movement of the garage door 4 (or the movement of the mechanical means by which the garage door 4 is moved) and instruct the deployment mechanism 40 to rotate the support member 30 to retract the panels 20 out of the exposed opening 6 to the degree the garage door 4 is closed, all the way to the point that the garage door 4 is fully closed and the panels 20 are fully retracted.

Embodiments of the covering 10 may further comprise the panels 20 being configured to releasably and repeatedly couple to one another at one or more points along the space 26, as desired by the user. Fasteners, such as hook and loop fasteners, zippers, buttons, snaps, and the like may be utilized to releasably and repeatedly couple neighboring panels 20 to one another at any point along the space 26 between neighboring panels 20.

Embodiments of the covering 10 may further comprise one or more of the panels 20 being configured to releasably and repeatedly couple to itself at one or more points along the length of the panel 20, as desired by the user. In other words, the user may manually adjust the length of the each panel 20, according to user preference, by manually attaching the lower regions of the panel 20, such as the second end 24, to another point along the length of the panel 20 that reduces the overall length of the panel 20. Fasteners, such as hook and loop fasteners, zippers, buttons, snaps, and the like may be utilized to releasably and repeatedly couple the second end 24 of the panel 20 to the panel 20 itself to reduce the overall length of the panel 20.

Embodiments of the covering 10 may further comprise the panels 20 being configured to have placed thereon, or printed thereon, one or more screen prints, photos, designs, emblems, pictures, images, symbols, signs, patterns, insignia, decorations, logos, or other user-desired, identifying information, as the user sees fit. The covering 10 may have placed thereon a plurality or combination of any of the above. For example, and not in any way limiting, each panel 20 may have a plurality of the above printed thereon or attached thereto. Conversely, the plurality of panels 20, collectively, may have placed thereon the desired pattern or print, such that each panel 20 forms a part of the whole image or pattern. The covering 10 therefore be configured to have a custom-made, user-identified image positioned, placed, or adhered to the covering 10 by way of the panels 20.

The components defining the above-described covering 10 may be formed of any of many different types of materials or combinations thereof that can readily be formed into shaped objects provided that the components selected are consistent with the intended operation of a covering for a garage opening of the type disclosed herein. For example, and not limited thereto, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described covering 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A covering for a garage door opening, the covering comprising:
a plurality of panels configured to transition between a retracted position and a deployed position;
a support member coupled to a garage door, the support member configured to support the plurality of panels thereby, the support member configured to functionally engage the plurality of panels;
a deployment mechanism functionally coupled to the support member and configured to operate to transition the plurality of panels between the retracted position and the deployed position; and
a weighted member coupled to a distal end of each of the plurality of panels.

2. The covering of claim 1, wherein under a condition the garage door is in a closed position the plurality of panels are in the retracted position, and wherein under a condition the garage door is in an open position the plurality of panels are in the deployed position to cover at least a portion of the garage door opening.

3. The covering of claim 1, further comprising a positioning member functionally coupled proximate a distal end of the garage door, wherein the positioning member is configured to functionally engage the plurality of panels to place a portion of each panel proximate the distal end of the garage door under a condition the garage door is open and the plurality of panels are in the deployed position.

4. The covering of claim 1, wherein each of the weighted members further comprises coupling members, the coupling members being configured to functionally engage one another to releasably couple adjacent panels of the plurality of panels to one another.

5. The covering of claim 1, wherein at least one panel of the plurality of panels exhibits diaphanous properties.

6. The covering of claim 1, wherein the plurality of panels substantially covers the garage opening without contacting a ground surface.

7. The covering of claim 2, wherein at least one panel of the plurality of panels deploys and retracts to the degree the garage door opens and closes, respectively.

8. The covering of claim 3, wherein the positioning member is positioned closer to the distal end of the garage door than is the support member.

9. The covering of claim 3, wherein the each panel is configured to drape over the positioning member.

10. A system for covering for a garage door opening, the system comprising:
a plurality of panels configured to transition between a retracted position and a deployed position, wherein adjacent panels of the plurality of panels define therebetween an opening;
at least one support member coupled to a garage door, the at least one support member configured to support a corresponding number of the plurality of panels thereby, the at least one support member configured to functionally engage the corresponding panels;
a deployment mechanism functionally coupled to the at least one support member and configured to operate to transition the corresponding panels between the refracted position and the deployed position; and
a positioning member functionally coupled proximate a distal end of the garage door, wherein the positioning member is configured to functionally engage the plurality of panels; and
a coupling member configured between distal ends of adjacent panels,
wherein under a condition the garage door is open and the plurality of panels are in the deployed position, the positioning member places a portion of each panel proximate the distal end of the garage door and the coupling member permits adjacent panels to disengage from one another under applied force and to operatively couple to one another in an absence of the applied force.

11. The system of claim 10, wherein under a condition the garage door is in a closed position the plurality of panels are in the retracted position, and wherein under a condition the garage door is in an open position the plurality of panels are in the deployed position to cover at least a portion of the garage door opening.

12. The system of claim 10, wherein the plurality of panels each exhibit diaphanous properties.

13. The system of claim 10, wherein the plurality of panels substantially covers the garage opening from a distal end of the garage door to a ground surface without contacting the ground surface.

14. The system of claim 10, further comprising a coupler positioned proximate the distal end of each panel of the plurality of panels and a securing strap, wherein the securing strap is configured to operatively engage each coupler to retain the panels in position with respect to one another.

15. The system of claim 10, wherein the positioning member is positioned closer to the distal end of the garage door than is the support member.

16. The system of claim 10, wherein the each panel is configured to drape over the positioning member.

17. A system for covering for a garage door opening, the system comprising:
a plurality of panels exhibiting diaphanous properties configured to transition between a refracted position and a deployed position, wherein adjacent panels of the plurality of panels define therebetween an opening;
a plurality of support members coupled to a garage door, each of the plurality support members being configured to support a corresponding number of the plurality of panels thereby, each of the support members being configured to functionally engage the corresponding panels;
a deployment mechanism functionally coupled to a corresponding support member of the plurality of support members and configured to operate the support member to transition the corresponding panels between the retracted position and the deployed position; and
a positioning member functionally coupled proximate a distal end of the garage door, wherein the positioning member is configured to functionally engage the plurality of panels such that the positioning member has draped thereover the plurality of panels and places a portion of the panel proximate the distal end of the garage door; and
a coupling member configured between distal ends of adjacent panels,
wherein under a condition the garage door is open and the plurality of panels are in the deployed position the coupling member permits adjacent panels to disengage from one another under applied force and to operatively couple to one another in an absence of the applied force.

18. The system of claim 17, wherein each support member of the plurality of support members is configured to operate independently of other support members to transition the corresponding plurality of panels between the retracted position and the deployed position.

19. The system of claim 18, wherein each support member of the plurality of support members is configured to operate independently of other support members to transition the corresponding plurality of panels to cover at least a portion of the garage door opening.

20. The system of claim 17, further comprising a coupler positioned proximate the distal end of each panel of the plurality of panels and a securing strap, wherein the securing strap is configured to operatively engage each coupler to retain the panels in position with respect to one another.
